(19) United States
(12) Patent Application Publication
(10) Pub. No.: US 2014/0174849 A1
(43) Pub. Date: Jun. 26, 2014

(54) INCREASING THE SOUND ABSORPTION IN FOAM INSULATING MATERIALS

(71) Applicant: Peter Gansen, Seeburg (DE)

(72) Inventor: Peter Gansen, Seeburg (DE)

(73) Assignee: OTTO BOCK SCHAUMSYSTEME GMBH, Duderstadt (DE)

(21) Appl. No.: 14/232,513

(22) PCT Filed: Jul. 13, 2012
(86) PCT No.: PCT/DE2012/000711

§ 371 Date: Jan. 13, 2014

(30) Foreign Application Priority Data
Jul. 13, 2011 (DE) 102011107693.3

(51) Int. Cl. G10K 11/168; B32B 5/24; C08J 9/00

(52) U.S. Cl. CPC G10K 11/168; C08J 9/0023; B32B 5/245
USPC 181/294; 264/45.3

(57) ABSTRACT

The invention relates to the use of expandable graphite having a starting temperature greater than or equal to 150° C. for increasing the sound absorption within a sound absorption foam material foamed with the expandable graphite, wherein the foam material is a polyurethane foam material. An associated sound absorber having a sound absorption foam material made of a polyurethane integral foam or polyurethane flexible foam, which is open-cell at least in the core region thereof, has a density greater than or equal to 120 g/l and a content of at least 5 wt % of expandable graphite to 100 parts by weight of isocyanate-reactive components, in particular polyol. The sound absorber can preferably be used for sound absorption in engine compartments of motor vehicles. The sound absorber can also be used very advantageously inside relatively complex components and in the design-dependent cavities of machines.

The invention relates to enhancing the degree of the sound absorption in foam insulants and to a sound absorber comprising a sound-absorbing foam which is open-cell in its core region at least.

Insulating foams are a significant group of insulants to be used exclusively or otherwise for sound insulation. These foams can be intended exclusively for sound insulation or be used for thermal insulation as well as sound insulation. Sound insulants are intended to keep sound away from certain spaces or the environment by swallowing it up.

Sound insulation is generally concerned with the insulation of structureborne sound or airborne sound. Complete absorption is frequently very difficult to achieve. It is firstly usually impossible to achieve complete prevention of sound reflection or sound transmission; secondly, the complete shielding of the sound source can present a problem. Occasionally, sound reflection is even desired, for example to improve the acoustics of a room. Finally, the degree of sound absorption is also dependent on the frequency to be absorbed, i.e., the frequency spectrum. Acoustical foams can be used for example in the form of soundproofing mats, the sound-insulating effect of which is frequently augmented by a surface texture—pyramidal texture, dimpled texture or the like. Heavy-foam mats may be impregnated with high-viscosity liquids or contain heavy fillers (e.g., Ba₂SO₄) to increase the basis weight and/or the density. They are then primarily used for sound absorption in the low range of frequencies.

One way to reduce sound intensity consists in the actual absorption of sound, i.e., the transformation of sound energy into other forms of energy, generally into heat. The degree of sound insulation or absorption achieved is frequently characterized by means of an absorption coefficient or by means of the sound absorption degree α. The absorption coefficient, which varies between 0 and 1, increases with the amount of sound energy absorbed, and becomes 1 on complete absorption of sound energy. The absorption degree α corresponds to the absorption coefficient in %. An absorption coefficient of 1 is correspondingly equal to an absorption degree α of 100%.

DE 10 2004 054 646 discloses combining an open-cell polyurethane foam (also called the spring in this context) for absorbing airborne sound by means of the open-cell pores with a heavier material—which is also called a mass and which consists of a polyurethane admixed with high-gravity solids. The mass, i.e., the heavier material, serves to absorb structureborne sound and reflect airborne sound. Barium sulfate is one example of useful high-gravity solids.

DE 27 35 153 A1 discloses a spring-mass system in the form of a soundproofing double mat. The double mat consists of two differingly dense polyurethane foams, of which the denser one is filled with a high-gravity filler, viz., barium sulfate, slate flour or chalk. Special polyurethane compositions are required on account of the high filler content.

Closed-cell polyurethane foams which also have a thermally insulating effect are also known, for example from DE 103 10 907 B3.

The known sound-insulating materials are disadvantageous in that they use inorganic high-gravity solids, the availability or environmental compatibility of which is frequently limited. Alternatively, the various densities within foams are also established with complicated techniques, which can be inconvenient and costly.

The invention has for its object to use relatively simple means to provide an economical sound insulant which has an improved sound-absorbing effect while also having a sound-insulating effect.

The invention is based on the surprising observation that expandable graphite when used as an additive in airborne sound absorbers, in particular airborne sound absorbers composed of foams, engenders an improvement in sound absorption across a wide spectrum of frequencies. This holds specifically for airborne sound absorbers of comparatively higher density in that they display superior sound insulation than inherently good airborne sound absorbers of low density.

The object of the invention is achieved by the use of expandable graphite as per claim 1, the sound absorber as per claim 8 and the engineered part as per claim 15.

True, DE 41 30 335 A1 already discloses using pre-expanded expandable graphite under admixture of salts in porous panels of predominantly inorganic material inter alia for soundproofing purposes. However, these panels are hard and brittle and have a very limited field of use.

Expandable graphite is a graphite with intercalated guest molecules. So-called expandable salts or “graphite intercalation compounds (GICs)” are intercalated between the carbon layers of the graphite. The intercalated molecules are usually sulfur or nitrogen compounds, for example SO₂. The properties of the expandable graphite emerge from the type and amount of the intercalation compounds and also from their distribution within the graphite layers. The action of heat causes the layers to be driven apart by thermolysis and to expand into a porous mass, the final volume of which can be several hundred times the initial volume. The expansion starts at different temperatures depending on the variety of the expandable graphite. And the expansion can take place abruptly. Expandable graphites are characterized in terms of their initiation temperatures and their expansion capacity. They are very frequently used for intumescent coatings and/or flameproofing. Alternatively, they are used for example as absorbents for liquids, e.g., oils. Since there is a high-volume demand for expandable graphite for this purpose, it is available at low cost. Expandable graphite is free from heavy metal and therefore relatively environmentally friendly. Within foams, expandable graphite is used for flameproofing furniture foams and mattresses.

The graphite layers of expandable graphite are comparatively easy to displace relative to each other even below the expansion temperature and are able to absorb energy in the process. The sound-absorbing ability is currently believed to be due to this although the theoretical background has not as yet been fully resolved. The expandable graphite—or the foam structure caused by the expandable graphite—appears to be capable of efficiently absorbing sound energy without an expansion occurring, which would be undesirable on account of the great volume of expansion.

In principle, any type of expandable graphite can be used within the insulant. It is currently believed, without wishing to be tied to any one theory, that all expandable graphites are capable of sound energy absorption due to their layers having been made more mobile by intercalation.

The current preference is for the use of an expandable graphite whose aggregate diameter is on average between 0.3 and 1.5 mm. Aggregate diameter refers to the largest diameter of a spherically, elongatedly or irregularly shaped aggregate of graphite platelets. Expandable graphite aggregates are also referred to as flakes. Individual diameters are for example determined visually (e.g., by measurement under the microscope) and the values obtained are averaged.

The initiation temperature of the expandable graphite used shall be not less than 150° C., which is the case for most grades. It is further preferable for the expandable graphite to have an initiation temperature of not less than 180° C., 200° C. or more preferably 250° C. The corresponding expandable graphite to be used according to the present invention are selected according to the intended purpose. This selection shall be made such that an even perhaps adventitious thermal stress on the sound-insulating material does not result in the occurrence of an unintended expansion on the part of the graphite, i.e., the expandable graphite is always used in the present invention in its non-expanded ground state and to perform its sound-insulating function in the foam must not expand either during production or in use.

The selected sound-insulating/absorbing foams are preferably open-cell or, in the case of integral foams, are open-cell in the core region, i.e., away from a densified surficial layer.

The sound-absorbing foams employed in the use according to the present invention preferably have a density of not less than 120 g/l, more preferably of not less than 150 g/l and even more preferably of not less than 200 g/l.

The sound-absorbing foams of the present invention further have densities of not more than 350 g/l and especially not more than 300 g/l.

Density has a profound influence on sound insulation properties. The preferred density ranges recited have proved to be particularly advantageous in cooperation with the added expandable graphite. They offer a good sound-absorbing and sound-insulating effect. They apply particularly for the use of flexible or integral polyurethane foams.

A foam admixed with expandable graphite can replace those acoustical foams which were hitherto admixed with high-gravity solids. By using expandable graphite in the manner of the present invention it is possible to replace conventional mass-spring systems. Since good absorption of sound is achieved across a larger range of frequencies, there is frequently no need to use two or more sound-insulating materials in one sound absorber, or sound-insulating engineered part. A unitary insulant according to the invention provides satisfactory sound absorption results for many application sectors.

A flexible sound-absorbing foam according to the present invention, having enhanced sound absorption due to the use of expandable graphite, may be preferably embodied in the form of roll material or panels, in which case textured surfaces, such as pyramidal or dimpled surfaces, can additionally be employed. A present invention flexible sound-absorbing foam comprising expandable graphite can also be cut into articles having any desired three-dimensional shape.

An integral sound-absorbing foam according to the present invention, wherein expandable graphite is used for sound absorption, may preferably be foamed up directly in the mold to form the desired parts. The foam can densify in the outer zone to form a sound absorber comprising mass and spring. The expandable graphite may be incorporated in one or more foam-forming components in order that the desired expandable graphite-containing material may be obtained at the end of the manufacturing operation.

The amount of expandable graphite employed per 100 parts by weight of a sound-absorbing foam is preferably from 3 to 60 and more preferably from 5 to 50 parts by weight.

In a particularly preferred embodiment of the use in polyurethane foams in the manner of the present invention, from 5 to 40 parts by weight of expandable graphite are included per 100 parts by weight of the isocyanate-reactive component, preferably per 100 parts by weight of a polyol component.

For use in sound-absorbing foams, production most favorably takes the form of mixing the expandable graphite, in the usual finely divided or flake-shaped form, into at least one of the foam-forming components before the mass is foamed up.

The insulant of the present invention has particularly good acoustical properties in respect of sound absorption and/or sound insulation. Both sound reflection and sound transmission are distinctly reduced.

Surprisingly, however, the novel sound-absorbing foams comprising expandable graphite were additionally found to have an enhanced level of thermal stability for the foam in that the plastic deformability of the material under its own weight (when measured across several days at 150° C. test temperature) decreases. The additional improvement in thermal stability, coupled with the concurrent improvement in sound absorption, is unexpected and improves the properties of the insulant, and/or of the sound absorber formed therefrom, as a whole. The effect does not occur at low densities (which are not in accordance with the present invention).

The particularly good sound-absorbing properties arise within the preferred density ranges determined in the context of the invention.

The preferred polyurethane foam may be a customary flexible foam or integral foam. The foam in question is preferably an open-cell foam, at least in its core phase, i.e., away from a surface layer, which is also known as skin or densification zone, in the case of an integral foam.

These foams are well known to a person skilled in the art and therefore need not be described here in detail in terms of their chemistry.

They are produced by the reaction of organic polyisocyanates, for example MDI or TDI, which can each be chemically modified or else be used in the form of prepolymers, with higher-functional compounds having two or more reactive hydrogen atoms, the so-called isocyanate-reactive component. The isocyanate-reactive component frequently comprises polyoxyalkylenepolyamines or polyhydroxy compounds, in particular polyols or polyether alcohols having molecular weights between, for example, 300 and 20 000. Optional admixtures are chain-extending and/or crosslinking agents, which comprise relatively low molecular weight components which are isocyanate reactive or react with OH groups or active hydrogen and frequently have molecular weights between 100 and 500 and functionalities between 2 and 10. The reaction mixture typically further contains catalysts, blowing agents, auxiliaries and/or added substances, for example fillers, dyes, photoprotectants, stabilizers and the like and also, optionally, low amounts of water.

A comprehensive overview of the production of integral and flexible polyurethane foams is given in the “Polyurethane Handbook” by Günther Oertel (ed.) Hansa, Munich, 1994, in particular chapters 3, 5 and 7.

The sound insulants where expandable graphite is employed according to the present invention can be used in a further development of the invention within an engineered part comprising two or more layers or within a complex part.

The achievement of the object further comprises a sound absorber comprising an integral or flexible sound-absorbing polyurethane foam which is open-cell in the core region at least, as described above, having a density ρ of not less than 120 g/l and an inclusion of not less than 5 parts by weight of expandable graphite per 100 parts by weight of isocyanate-reactive component, in particular polyol.

The sound absorber may preferably be used for sound absorption in engine compartments of motor vehicles, since the sound absorber, as detailed above, also has good thermal stability in an operating range of up to about 160° C. Preferred applications concern sound insulation in gasoline pump covers and engine compartment covers.

The sound absorber can consist wholly of the sound-absorbing foam of the present invention or be connected thereto in a part. The sound absorber may likewise have a multilayered construction or consist of two or more integral foam moldings. This makes it possible to actualize particular spatial distributions of mass and spring.

In preferred exemplary embodiments, the expandable graphite content is aligned with the density of the foam and adjusted such that the sound-absorbing foam evinces an improvement in the sound absorption degree α, measured at 2000 Hz, of Δα of not less than 5% over an equal-density reference foam produced without the expandable graphite but otherwise the same.

The expandable graphite is in turn an expandable graphite which expands at a temperature not less than 150° C., preferably 180° C. and more preferably 250° C.

This allows safe usage at conditions far above room temperature and, for example, even in the bodywork region and in the engine compartment of motor vehicles, airplanes and ships.

The sound absorbers of the present invention also achieve a V-0 rating in the UL 94 vertical flame test, the international standard.

The sound-absorbing foam of the sound absorber in a preferred aspect of the invention is a flexible polyurethane foam obtained using long-chain polyols, i.e., reactive polyols having an OH number (OH number measurement by the phthalic anhydride method) below 100 and an isocyanate, as known to a person skilled in the art of flexible foam production, i.e., in particular at least an aromatic isocyanate having a functionality between 2.0 and 2.5. In a particularly preferred embodiment, from 1 to 5 parts by weight are additionally admixed per 100 parts by weight of the polyol. Customary auxiliary and added-substance materials/additives can be present.

The sound-absorbing foam of the sound absorber in a further preferred aspect of the invention is an integral polyurethane foam obtained using long-chain polyols, i.e., reactive polyols having an OH number below 100 under admixture of chain extenders and/or crosslinkers, with an isocyanate, as known to a person skilled in the art of integral foam production, i.e., preferably at least an aromatic isocyanate having a functionality between 2.0 and 2.5, optionally under admixture of physical or chemical blowing agents. The chain extenders, which are preferably difunctional, are preferably used in a proportion between 3 and 11 wt %. The boundary between crosslinkers and chain extenders can be fluid. Specific crosslinkers can optionally be used in addition to the chain-extending agents. In a particularly preferred embodiment, from 0.1 to 1 part by weight of water is additionally admixed per 100 parts by weight of the polyol. Customary auxiliary and added-substance materials, or additives, can be present.

All the foams can include the customary additives, as described above.

In a particularly preferred embodiment, the sound absorber comprises a sound-absorbing PU foam which is in the form of an integral polyurethane foam molding which has an outer densification zone (skin) from 0.5 to 5 mm in thickness, while the integral foam part in at least a region, i.e., one or more spatially separate regions, of the molding surface, preferably on a side facing a sound generator, has a skin not more than 0.1 mm in thickness. The sound absorber molding can optionally be machined and/or connected to other materials. Machining can also take the form of cutting the molding after demolding.

In a further preferred embodiment, the integral polyurethane foam molding has no skin and is open-cell in the at least one region of the molding surface, as described above, which is achievable via a cut face. This cut face, if desired, can be conformed in its geometry to the surface of a sound generator.

The invention finally also comprises an engineered part comprising a sound absorber as described above. A comparatively complex part may be concerned here in that it may, for example, contain the sound absorber of the invention embedded in engineered cavities.

### EXAMPLES AND TEST RESULTS

The following components were used for Examples 1 to 14 as reported in accompanying table 1:

Polyol 1:

85 parts by weight of a trifunctional polyether polyol having 13% of terminally polymerized oxyethylene groups and an OH number of 35 (polyol A),

15 parts by weight of a trifunctional polyether polyol having 20% of PHD filler and 17.5% of terminally polymerized oxyethylene groups with an OH number of 28 (polyol B),

10 parts by weight of monoethylene glycol,

0.4 part by weight of bis(dimethylaminopropyl)methylamine,

1.0 part by weight of water,

0.05 part by weight of Fomrez UL 28 (10% stock batch) from Momentive,

1.0 part by weight of Tegostab® B 4690 from Evonik Industries,

0.1 part by weight of 2-methylpentamethylenediamine,

10 parts by weight of diphenyl cresyl phosphate,

5 parts by weight of 1,1,1,3,3-pentafluoropropane.

Polyol 2:

85 parts by weight of polyol A,

15 parts by weight of polyol B,

10 parts by weight of monoethylene glycol,

0.4 part by weight of bis(dimethylaminopropyl)methylamines,

1.0 part by weight of water,

0.05 part by weight of Fomrez UL 28 (10% stock batch) from Momentive,

1.0 part by weight of Tegostab® B 4690 from Evonik Industries,

0.1 part by weight of 2-methylpentamethylenediamine,

10 parts by weight of diphenyl cresyl phosphate.

Polyol 3 (for the Reference Examples to Illustrate a Foam of Lower Density (See Table Examples 13 and 14)

85 parts by weight of a trifunctional polyether polyol having 17.6% of terminally polymerized oxyethylene groups and an OH number of 28,

15 parts by weight of polyol B,

0.4 part by weight of bis(dimethylaminopropyl)methylamine,

3.0 parts by weight of water,

0.1 part by weight of dibutyltin dilaurate,

1.2 parts by weight of Tegostab® B 4690 from Evonik Industries,

0.8 part by weight of 2-methylpentamethylenediamine,

10 parts by weight of diphenyl cresyl phosphate.

Isocyanate 1:

20 parts by weight of MDI with 77% monomer, 23% polymer and 20% prepolymer,

80 parts by weight of monomeric MDI with 23% carbodiimide.

Isocyanate 2: (For the Reference Examples to Illustrate a Foam of Lower Density (See Table):

70 parts by weight of Desmodur® T 80 (commercial product from Bayer AG),

30 parts by weight of Desmodur® 44 V 20 (commercial product from Bayer AG).

Expandable graphite 1: average flake size 0.4 mm.

Expandable graphite 2: average flake size 0.7 mm.

Expandable graphite 3: average flake size 1.1 mm.

The polyurethane foams were produced by mixing the appropriate polyol (1-3) with the isocyanate (1 or 2) at 4000 rpm with a Heidolph stirring apparatus equipped with a four-blade stirrer with 90° angled tips and introduced into a cuboid-shaped metallic mold.

The integral foam moldings (Examples 1-12) were demoldable after 10 min at a mold temperature of 45° C.

The flexible foam moldings (Examples 13 and 14) were demoldable after 7 min at a mold temperature of 60° C.

Acknowledgement:

The acoustical performance test results were obtained in collaboration with the BIK institute for integrated product development & Steinbeis transfer center 660 in Bremen.

TABLE 1

| | | | | | Tensile | Elongation at | Absorption in |
|---|---|---|---|---|---|---|---|
| | | | Polyol: | Overall | strength (kPa) | break (%) | impedance tube |
| | | | isocyanate | density | DIN EN | DIN EN | at a frequency |
| | Polyol | Isocyanate | mixing ratio | (kg/m³) | ISO 1789 | ISO 1789 | of 2000 Hz |
| Example 1 | polyol 1 | isocyanate 1 | 100:53 | 200 | skin: 981 | skin: 86 | 0.38 |
| | | | | | foam: 760 | foam: 115 | |
| Example 2 | polyol 1 + 30 pbw of | isocyanate 1 | 100:43 | 200 | skin: 556 | skin: 58 | 0.72 |
| | expandable graphite 1 | | | | foam: 312 | foam: 66 | |
| Example 3 | polyol 1 + 30 pbw of | isocyanate 1 | 100:43 | 200 | skin: 484 | skin: 53 | 0.72 |
| | expandable graphite 2 | | | | foam: 326 | foam: 66 | |
| Example 4 | polyol 1 + 30 pbw of | isocyanate 1 | 100:43 | 200 | skin: 481 | skin: 54 | 0.91 |
| | expandable graphite 3 | | | | foam: 335 | foam: 50 | |
| Example 5 | polyol 1 + 20 pbw of | isocyanate 1 | 100:46 | 200 | skin: 541 | skin: 54 | 0.53 |
| | expandable graphite 3 | | | | foam: 486 | foam: 68 | |
| Example 6 | polyol 1 + 10 pbw of | isocyanate 1 | 100:50 | 200 | skin: 736 | skin: 71 | 0.57 |
| | expandable graphite 3 | | | | foam: 681 | foam: 107 | |
| Example 7 | polyol 2 | isocyanate 1 | 100:56 | 350 | skin: 2893 | skin: 109 | 0.26 |
| | | | | | foam: 1592 | foam: 112 | |
| Example 8 | polyol 2 + 30 pbw of | isocyanate 1 | 100:45 | 350 | skin: 1400 | skin: 52 | 0.23 |
| | expandable graphite 2 | | | | foam: 994 | foam: 79 | |
| Example 9 | polyol 2 + 30 pbw of | isocyanate 1 | 100:45 | 350 | skin: 1583 | skin: 71 | 0.27 |
| | expandable graphite 3 | | | | foam: 1166 | foam: 86 | |
| Example 10 | polyol 2 | isocyanate 1 | 100:56 | 500 | skin: 4515 | skin: 100 | 0.19 |
| | | | | | foam: 2206 | foam: 98 | |
| Example 11 | polyol 2 + 30 pbw of | isocyanate 1 | 100:45 | 500 | skin: 3334 | skin: 75 | 0.22 |
| | expandable graphite 2 | | | | foam: 1832 | foam: 98 | |
| Example 12 | polyol 2 + 30 pbw of | isocyanate 1 | 100:45 | 500 | skin: 2699 | skin: 53 | 0.19 |
| | expandable graphite 2 | | | | foam: 1587 | foam: 84 | |
| Example 13 | polyol 3 | isocyanate 2 | 115:35 | 105 | 188 | 149 | 0.72 |
| Example 14 | polyol 3 + 30 pbw of | isocyanate 2 | 145:35 | 105 | 149 | 83 | 0.88 |
| | expandable graphite | | | | | | |

1. A method of using expandable graphite to enhance sound absorption, comprising:
providing a sound-absorbing foam and an expandable graphite having an initiation temperature of not less than 150° C. to enhance a degree of sound absorption within the sound-absorbing foam;
expanding the sound-absorbing foam with the expandable graphite;
wherein the sound-absorbing foam is a polyurethane foam.

2. The method as claimed in claim 1, wherein the sound-absorbing foam is an open-cell foam.

3. The method as claimed in claim 1, wherein the sound-absorbing foam is an integral foam which is open-cell in a core region of the sound-absorbing foam.

4. The method as claimed in claim 1, wherein the foam has a density of not less than 120 g/l, in particular of not less than 150 g/l and more preferably of not less than 200 g/l.

5. The method as claimed in claim 1, wherein not less than 5 parts by weight of expandable graphite are included per 100 parts by weight of the isocyanate-reactive component of the polyurethane.

6. The method as claimed in claim 5, wherein from 5 to 40 parts by weight of expandable graphite are included per 100 parts by weight of the isocyanate-reactive component.

7. The method as claimed in claim 1, further comprising forming an engineered part comprising two or more layers or a complex part from the sound-absorbing foam.

8. A sound absorber comprising:
an integral or flexible sound-absorbing polyurethane foam having a core region and which is open-cell in at least the core region, the sound-absorbing foam comprising:
a density ρ of not less than 120 g/l;
a composition of not less than 5 parts by weight of expandable graphite having an initiation temperature of not less than 150° C. per 100 parts by weight of isocyanate-reactive component.

9. The sound absorber as claimed in claim 8, wherein the sound-absorbing foam evinces an improvement in the sound absorption degree α, measured at 2000 Hz, of Δα of not less than 5% over an equal-density reference foam produced without the expandable graphite but otherwise the same.

10. The sound absorber as claimed in claim 8, wherein the sound-absorbing foam is a flexible polyurethane foam as obtainable from a reactive polyol having an OH number below 100, an isocyanate and between 1 and 5 wt % of water and also auxiliary and added-substance materials.

11. The sound absorber as claimed in claim 8, wherein the sound-absorbing foam is an integral polyurethane foam as obtainable from a reactive polyol having an OH number below 100, an isocyanate, between 0 and 1 wt % of water, between 3 and 11 wt % of preferably difunctional chain extenders, optionally under admixture of further crosslinkers, and also auxiliary and added-substance materials.

12. The sound absorber as claimed in claim 8, further comprising an integral polyurethane foam molding which is optionally machined and/or connected to other materials and which has an outer densification zone (skin) from 0.5 to 5 mm in thickness and which in at least a region of the molding surface has a skin not more than 0.1 mm in thickness.

13. The sound absorber as claimed in claim 8, wherein the integral polyurethane foam molding has no skin and is open-cell in at least a region of the molding surface.

14. The sound absorber as claimed in claim 8, further comprising a gasoline pump cover or an engine compartment cover.

15. An engineered part comprising a sound absorber as claimed in claim 8.

16. The method of claim 6, wherein the isocyanate-reactive component comprises a polyol component.

17. The sound absorber of claim 8, wherein the isocyanate-reactive component comprises polyol.

18. The sound absorber of claim 12, wherein the region of the molding surface includes a side facing a sound generator.

19. The sound absorber of claim 13, wherein the region of the molding surface includes a side facing a sound generator.
